(19) United States
(12) Patent Application Publication
(10) Pub. No.: US 2014/0277613 A1
(43) Pub. Date: Sep. 18, 2014

(54) EMERGENCY STOP SYSTEM FOR AN AUTOMATION AND MOTION CONTROL SYSTEM

(71) Applicant: TAIT TOWERS MANUFACTURING, LLC, Lititz, PA (US)

(72) Inventors: James D. LOVE, Lititz, PA (US); Scott FISHER, Las Vegas, NV (US)

(21) Appl. No.: 13/827,812

(22) Filed: Mar. 14, 2013

(51) Int. Cl. G05B 15/02

(52) U.S. Cl. CPC G05B 15/02
USPC 700/83

(57) ABSTRACT

An emergency stop system for an automation and motion control system enables an operator to connect a portable, handheld control device to the automation and motion control device anywhere in the system and provide a “stop” command to the emergency stop system.

### BACKGROUND

The application generally relates to an automation and motion control system for the entertainment industry. The application relates more specifically to an emergency stop system for an automation and motion control system that permits a portable, handheld device to connect to and transmit emergency stop commands from any location in the automation and motion control system.

In the entertainment industry, to provide a realistic atmosphere for a theatrical production, theatrical objects or components can be moved or controlled by an automation and motion control system during (and between) scenes on a stage or takes on a motion picture production set. Automation of the movement and control of the theatrical objects or components is desirable for safety, predictability, efficiency, and economics. An emergency stop (e-stop) system can be used with the automation and motion control system to prevent dangerous situations from occurring that could injure people or property. An e-stop system can be used to simultaneously and instantaneously de-energize and stop all components connected to the e-stop system. Previously, e-stop systems were implemented as separate systems from the automation and motion control system. In other words, the e-stop system had its own network, control system and control devices, e.g., pushbuttons, that were separate from the network of the automation and motion control system. To avoid the need for a duplicate system, the e-stop system was integrated into the automation and motion control system to use the same network for communication. However, one disadvantage of the previous e-stop systems, whether separate or integrated into the automation and motion control system is that the locations of the control devices that could initiate the “stop” command were fixed in location causing a person to have to take extra time to locate a control device if the person was not next to the control device.

Therefore, what is needed is an emergency stop system for an automation and motion control system that can enable an operator to connect a portable, handheld control device to the automation and motion control device anywhere into the system and provide a “stop” command for the emergency stop system.

### SUMMARY

The present application is directed to an automation and motion control system to control a plurality of theatrical objects. The control system includes a plurality of nodes in communication with each other over a real time network. Each node of the plurality of nodes includes a microprocessor and a memory device. The control system also includes a safety controller connected to one node of the plurality of nodes. The safety controller is operable to implement an emergency stop system. The control system further includes a control device. The control device includes a connector to enable the control device to connect to a node of the plurality of nodes. The control device communicates with the safety controller over the real time network in response to being connected to the node of the plurality of nodes. The control device is operable to issue emergency stop commands to the safety controller once connected to the node of the plurality of nodes. The connector is configured to enable the control device to be disconnected from a first node of the plurality of nodes and connected to a second node of the plurality of nodes at a different location from the first node.

The present application is also directed to an emergency stop control device for an automation and motion control system. The control device includes a housing having a predetermined size to permit an operator to carry and hold the housing and a microprocessor and a memory device positioned inside the housing. The control device also includes a connector extending from the housing to connect to a node of the automation and motion control system and a stop control button located on the outer surface of the housing. The stop control button is operable to issue an emergency stop command to a safety controller of the automation and motion control system in response to being connected to the node and the stop control button being activated. The connector is configured to enable the control device to be disconnected from the node and connected to another node of the automation and motion control system at a different location.

The present application is further directed to a computer implemented method of using an emergency stop control device with an automation and motion control system. The method includes determining whether an emergency stop control device has been connected to an automation and motion control system, notifying a safety controller of the automation and motion control system that the emergency stop control device has been connected and receiving acknowledgement from the safety controller at the connected emergency stop control device. The method also includes determining whether a control button on the emergency stop control device has been activated and providing the safety controller with a command from the emergency stop control device in response to a determination that the control button on the emergency stop control device has been activated.

One advantage of the present application is the ability to have an e-stop control device at any location in the automation and motion control system.

Other features and advantages of the present application will be apparent from the following more detailed description of the preferred embodiment, taken in conjunction with the accompanying drawings which illustrate, by way of example, the principles of the application.

### BRIEF DESCRIPTION OF THE DRAWINGS

FIG. 1 schematically shows an exemplary embodiment of an automation and motion control system.

FIG. 2 schematically shows an alternate embodiment of an automation and motion control system.

FIG. 3 schematically shows an exemplary embodiment of an automation and motion control system with integrated emergency stop system components.

FIG. 4 schematically shows an exemplary embodiment of an emergency stop control device.

FIG. 5 shows an exemplary embodiment of a node with a connection for the emergency stop control device.

FIG. 6 shows an exemplary embodiment of a process for using the emergency stop control device with an automation and motion control system.

Wherever possible, the same reference numbers are used throughout the drawings to refer to the same or like parts.

### DETAILED DESCRIPTION OF THE EXEMPLARY EMBODIMENTS

FIG. 1 shows an exemplary embodiment of the automation and motion control system of the present application. The automation and control system 100 can include a real time network 110, interconnecting operator consoles 115, remote stations 120, safety systems 125, machinery 130, input/output devices 135 and external systems 140. In one exemplary embodiment, safety systems 125 can include emergency stop (e-stop) systems; machinery 130 can include lifts, chain hoists, winches, elevators, carousels, turntables, hydraulic systems, pneumatic systems, multi-axis systems, linear motion systems (e.g., deck tracks and line sets), audio devices, lighting devices, and/or video devices; input/output devices 135 can include incremental encoders, absolute encoders, variable voltage feedback devices, resistance feedback devices, tachometers and/or load cells; and external systems 140 can include show control systems, industrial protocols and third party software interfaces including 0-10 V (volt) systems, Modbus or Modbus TCP systems, Profibus systems, ArtNet systems, BMS (Building Management System) systems, EtherCAT® systems, DMX systems, SMPTE (Society of Motion Picture and Television Engineers) systems, VITC systems, MIDI (Musical Instrument Digital Interface) systems, MANET (Mobile Ad hoc NETwork) systems, K-Bus systems, Serial systems (including RS 485 and RS 232), Ethernet systems, Open Source Controls (OSC), TCP/IP (Transmission Control Protocol/Internet Protocol) systems, UDP (User Datagram Protocol) systems, ControlNet systems, DeviceNet systems, RS 232 systems, RS 45 systems, CAN bus (Controller Area Network bus) systems, Maya systems, Lightwave systems, Catalyst systems, 3ds Max or 3D Studio Max systems, and/or a custom designed system.

FIG. 2 shows an alternate embodiment of the automation and motion control system. The automation and motion control system 100 shown in FIG. 2 can be formed from the interconnection of logical nodes 210. Each node 210 can be associated with a specific component or device (or group of devices) from remote stations 120, safety systems 125, machinery 130, input/output devices 135 and external systems 140. An operator console node 215 can be associated with a specific device from operator consoles 115 and can enable an operator to interact with the control system 100, i.e., to send data and instructions to the control system 100 and to receive data and information from the control system 100. The operator console node 215 is similar to the other nodes 210 except that the operator console node 215 can include a graphical user interface (GUI) or human-machine interface (HMI) to enable the operator to interact with the control system 100. In one exemplary embodiment, the operator console node 215 can be a Windows® computer.

In an exemplary embodiment, the operator(s) can make inputs into the control system 100 at operator console nodes 215 using one or more input devices, e.g., a pointing device such as a mouse, a keyboard, a panel of buttons, or other similar devices. As shown in FIG. 2, nodes 210 and operator console nodes 215 are interconnected with each other. Thus, any node 210, 215 can communicate, i.e., send and receive data and/or instructions, with any other node 210, 215 in the control system 100. In one exemplary embodiment, a group of nodes 210 can be arranged or configured into a network 212 that interconnects the nodes 210 in the group and provides a reduced number of connections with the other nodes 210, 215. In another exemplary embodiment, nodes 210, 215 and/or node networks 212 can be interconnected in a star, daisy chain, ring, mesh, daisy chain loop, token ring, or token star arrangement or in combinations of those arrangements. In a further exemplary embodiment, the control system 100 can be formed from more or less nodes 210, 215 and/or node networks 212 than those shown in FIG. 2.

In one exemplary embodiment, each node 210, 215 can be independently operated and self-aware, and can also be aware of at least one other node 210, 215. In other words, each node 210, 215 can be aware that at least one other node 210, 215 is active or inactive (e.g., online or offline).

In another exemplary embodiment, each node 210, 215 is independently operated using decentralized processing, thereby allowing the control system 100 to remain operational even if a node 210, 215 may fail because the other operational nodes 210, 215 still have access to the operational data of the nodes 210, 215. Each node 210, 215 can be a current connection into the control system 100, and can have multiple socket connections into the network 110, each providing node communications into the control system 100 through the corresponding node 210, 215. As such, as each individual node 210, 215 is taken “offline,” the remaining nodes 210, 215 can continue operating and load share. In a further exemplary embodiment, the control system 100 can provide the operational data for each node 210, 215 to every other node 210, 215 all the time, regardless of how each node 210, 215 is related to each other node 210, 215.

The communication between nodes 210, 215 can use a preselected communication protocol that enable the nodes 210, 215 to understand and share information, data and control instructions among the nodes 210, 215. Some examples of the communication protocol that can be used between nodes 210, 215 include EtherCAT®, TCP/IP, UDP, Modbus, Modbus TCP, CAN, ArtNet, OSC and DMX. To enable communication between a node 210, 215 and its corresponding connected device(s) or component(s), the automation and motion control system 100 can use a universal translator at each node 210, 215, as required, to convert or interpret the information, data and instructions associated with the component or device into the preselected communication protocol used by the nodes 210, 215 and the automation and motion control system 100. The universal translator enables two-way communication between the node 210, 215 and the component or device regardless of the communication protocol used by the component or device.

FIG. 3 shows another embodiment of the automation and motion control system with e-stop system components. As shown in FIG. 3, the control system 100 can include several nodes 210 connected together by the network 110. The nodes 210 can be associated with components 302, 303, a safety controller 304 and an e-stop control station 306. The components 302, 303 can be any suitable type of device such as a winch, lift, elevator, carousel, turntable, hydraulic system, pneumatic system, multi-axis system, linear motion system (e.g., deck tracks and line sets), audio device, lighting device, video device, input/output device or a chain hoist. The safety controller 304 can be any suitable control device (e.g., a programmable logic controller (PLC)), control system and/or control algorithm that can implement the e-stop system and any other appropriate safety system. The e-stop control station 306 can be any suitable control device including pushbutton stations (both wall mounted and handheld) and handheld controllers (with or without programmable buttons). The e-stop system can also include a portable, handheld, emergency stop control device 310 that can be connected to (and disconnected from) any node 210 in the control system 100. The emergency stop control device 310 operates similar to the e-stop control station 306 except that the emergency stop control device 310 can be carried with an operator. When an operator desires e-stop functionality, the operator can locate a node 210 and connect the emergency stop control device 310 to that node 210 to have instant e-stop functionality in the emergency stop control device 310. When the operator needs to move to a different location, the operator can disconnect the emergency stop control device 310 from the node 210 and move to a different node 210 and reconnect the emergency stop control device 310 to the new node 210 to regain e-stop capabilities in the emergency stop control device 310.

The safety controller 304 can receive an e-stop command from the e-stop control station 306 or the connected emergency stop control device 310 and can then issue “stop” commands to simultaneous and instantaneously de-energize and stop all system components. In another embodiment, a “stop” command from an e-stop control station 306 or a connected emergency stop control device 310 may be configured to apply to only a preselected group of system components (e.g., de-energizing all winches in a flying system but keeping a lighting system operational).

In one embodiment, the e-stop system components can be connected to the control system 100 using preselected e-stop input terminals and/or output terminals (or watchdogs) incorporated into each node 210 and/or the safety controller 304. In an exemplary embodiment, the e-stop system of the control system 100 can include a Twin SAFE® logic terminal EL6900, a Twin SAFE® input terminal EL1904, and a Twin SAFE® output terminal EL2904, all manufactured by Beckhoff Automation GmbH. In another embodiment, the e-stop system components can be connected to the control system 100 using any standard connection technique including Ethernet connections, universal serial bus (USB) connections, or wire terminals.

FIG. 4 shows an exemplary embodiment of a portable, handheld control device that can be used with the e-stop system. The emergency stop control device 310 can include a housing or unit 401 that can easily be held and carried by an operator. The housing 401 can include a stop control input device, interface or control button 402, a reset control input device, interface or control button 404 and one or more programmable control input devices, interfaces or control buttons 406. The emergency stop control device 310 may include a microprocessor and one or more memory devices that store control algorithms for the emergency stop control device 310. The control algorithms can be associated with the e-stop system or used to implement the programmable control input devices 406 and execute their corresponding commands. The stop control input device 402 can be used to issue the “stop” command to the safety controller to shut down one or more system components. The reset control input device 404 can be used to “reset” all of the shutdown components to their initial operating states. The programmable control input devices 406 can be programmed to provide related e-stop functionality such as “start” or “run” or to provide other functionality related to the control system 100. The stop control input device 402, reset control input device 404 and programmable control input devices 406 can be incorporated into the emergency stop control device 310 using any suitable mechanism or technique including, pushbuttons, selector switches or touchscreen controls or buttons. In other embodiments, the emergency stop control device 310 can include only the stop control input device 402 and the reset control input device 404 or only the stop control input device 402.

The emergency stop control device 310 can be connected to a node 210 using connector or plug 410 extending from the housing 401. The connector or plug 410 can incorporate any suitable powered connection configuration, i.e., power and control or communication are provided in the same connection, including Power over Ethernet (PoE) or USB to connect to the node 210. The powered connection can be used to directly power the emergency stop control device 310 or to charge batteries in the emergency stop control device 310 that then provides the power for the emergency stop control device 310. In another embodiment, the emergency stop control device 310 may be battery powered and can connect to the node 210 using any suitable communication connection such as an Ethernet connection.

In FIG. 5, a housing 502 can include both a node 210 and a component or device 303 that is controlled by the node 210. The component or device 303 can be any suitable type of device that can fit, or partially fit, within housing 502 such as a winch, lift, elevator, carousel, turntable, hydraulic system, pneumatic system, multi-axis system, linear motion system (e.g., deck tracks and line sets), audio device, lighting device, video device, input/output device or a chain hoist. A power control device 504 can be included in the housing 502. The power control device 504 can receive power from power lines 506 through an interface connection 508 and provide power to the device 303, the node 210 and any other component in the housing 502 that has a power requirement. In one embodiment, the power control device 504 can include one or more transformers (not shown). The node 210 can include an interface connection 508 through the housing 502 to provide input and/or output connections to the network 110 and the other nodes 210 and an interface connection 510 through the housing 502 that can provide a powered connection (e.g., a POE connection or USB connection) for the emergency stop control device 310. In another embodiment, if the emergency stop control device 310 has its own power supply, such as batteries, then the emergency stop control device can be connected using the same interface connection 508 as is used to connect to the network 110 and other nodes 210.

The node 210 includes a control/processing board or device 512. The control/processing board 512 can provide the primary control functions for the node 210 and can execute one or more control programs or processes to control operation of the component 303 and/or to share information, data and control instructions with other nodes and/or external devices. The control/processing board 512 can include one or more microprocessors and one or more memory devices. In one embodiment, the control/processing board 512 can exchange, i.e., send and receive, data, signals, instructions and/or information with the other nodes 210 connected to the network 110 and/or any connected external devices.

In one exemplary embodiment, the microprocessor(s) of the control/processing board 512 can execute one or more control programs or algorithms stored in the memory device(s) associated with the component 303. The control program or algorithm executed by the control/processing board 512 can provide the necessary control instructions to control operation of the component 303. For example, the control/processing board 512 can provide instructions or commands to control operation of the component 303, to turn on outputs, to send analog signals, to monitor incoming signals or inputs and/or to trigger audio commands. In addition, the control/processing board 512 can receive signals, instructions and/or information from the control system 100 and/or the other nodes 210, 215 and then can generate the appropriate response instructions or commands for the component 303 based on the received input. By having information on the operation of the other nodes 210, 215, the control/processing board 512 can generate the appropriate instructions or commands for the component 303 to provide for smooth operation of the system.

In one exemplary embodiment, the control algorithm(s) stored in the control board 512 can be executed in response to receiving a particular command or signal from control system 100. A command or signal from control system 100 could trigger the execution of a control algorithm in the control board 512 that would result in several individual actions being taken by the component 303. For example, a sequence of actions taken by the component 303 in response to a signal from the control system 100 could be to coordinate with other nodes 210, 215 after a predetermined time period.

In one exemplary embodiment, the component 303 can include one or more sensors to measure operating conditions or parameters of the component 303. Some examples of operating conditions or parameters that can be measured can include temperature, current, load or weight (load cell), angle, g-force or acceleration (accelerometer), direction of movement, or speed of movement. The sensors can then transmit the measured operational data to the control/processing board 512. The control/processing board 512 may then use some, all or none of this information during the execution of the control program and algorithm to determine and/or generate the appropriate commands. In one embodiment, the control/processing board 512 can also transmit the sensor data to the other nodes 210, 215 and/or the control system 100 to be used by the control programs or algorithms of the other nodes 210, 215 and/or the control system 100.

An exemplary embodiment of a process for using the emergency stop control device with an automation and motion control system is shown in FIG. 6. The process begins by determining or detecting whether a emergency stop control device 310 has been connected to a node 210 (step 602). The detection of the emergency stop control device 310 by the node can be done by any suitable technique. If the emergency stop control device 310 has not been connected, the process returns to the start and continues to detect for a emergency stop control device 310 to be connected to a node 210. If the emergency stop control device 310 has been connected, the node 210 or the emergency stop control device 310 (through the node 210) sends a message to the safety controller 304 notifying the safety controller 304 that the emergency stop control device 310 has been connected (step 604). After the safety controller 304 receives the message that the emergency stop control device 310 has been connected, the safety controller 304 returns an acknowledgement to the node 210 and/or emergency stop control device 310 (step 606) indicating that the safety controller 304 knows that the emergency stop control device 310 has been connected and that the safety controller 304 will accept inputs, e.g., warnings, alerts, commands, instructions, etc., from the emergency stop control device 310.

Once the emergency stop control device 310 has been acknowledged by the safety controller 304, the process continues by determining or detecting whether an input device or control button on the emergency stop control device 310 has been activated or pressed (step 608). If an input device or control button on the emergency stop control device 310 has been activated, a transmission or message is sent to the safety controller 304, notifying the safety controller that an input device on the emergency stop control device 310 has been activated (step 612) and providing the input, e.g., data, information, commands, instructions, or alerts, corresponding to the activated input device to the safety controller 304. The safety controller 304 processes the input from the emergency stop control device 310 and takes the appropriate action in view of the input from the emergency stop control device 310. The appropriate action may include de-energizing, stopping or shutting down all (or some) system components or resetting the operational status of any de-energized or stopped components. If the input device on the emergency stop control device 310 has not been activated, then the process determines or detects whether the emergency stop control device 310 has been disconnected from the node 210 (step 610). If the emergency stop control device 310 has been disconnected, the process returns to the start and detects for a emergency stop control device 310 to be connected to a node 210. If the emergency stop control device 310 has not been disconnected, the process returns to step 608 to determine if an input device on the emergency stop control device 310 has been activated.

In one exemplary embodiment, the emergency stop control device 310 can be any suitable portable, handheld device that can be programmed or configured to work with an emergency stop system. Some examples of portable, handheld devices include industrial control device or stations, smartphones, tablet computers or laptop computers.

In an exemplary embodiment, each node can include a computing device such as a process controller, a thin client, a palm top computer, single board computer (SBC), programmable logic controller (PLC), field programmable gate array (FPGA) device or a microprocessor, or the node can be a software device like a “player” or a “virtual machine” which is not a tangible piece of machinery capable of being held in one's hand but is instead a software construct that is considered by the control system to be a device. The software device can supply commands and receive back a status, yet doesn't exist as a physical device. In an exemplary embodiment, each node, whether a computing device or a software device, can execute the QNX real time operating system.

In one exemplary embodiment, the data for all nodes or devices, including data relating to the processes for the node or device, can be made universally available to every other node or device on the network all the time, so that every node or device is aware of the other nodes or devices. With regard to the transfer of data, there are no processor boundaries, and data is not deemed to reside on separate processors. If one node or device is controlled so as to care whether or not another node or device is going too fast, the corresponding data can be known by the node or device because all nodes or devices are constantly trading information via information packets (e.g., IP protocol packets) containing one or more data vectors. In one embodiment, the data can be stored, and made available to all the nodes, in a markup language format (e.g., eXtensible Markup Language—XML).

In another exemplary embodiment, nodes can share data with all the other nodes on the network using a redundant, load sharing, real time network that can reroute data traffic around damaged sections and alert operators to problems on the network. Each node is capable of storing all of the information the node requires to perform its role. Nodes can communicate with each other their current status (position, movement status, direction, velocity, health of the node, how long has it been in service (length of service), how much has it been used (amount of use)). When one node has a problem, the other nodes can know about the problem immediately and can be programmed on how to react to the problem/failure.

The present application contemplates methods, systems and program products on any machine-readable media for accomplishing its operations. The embodiments of the present application may be implemented using an existing computer processor, or by a special purpose computer processor for an appropriate system, or by a hardwired system.

Embodiments within the scope of the present application include program products comprising machine-readable media for carrying or having machine-executable instructions or data structures stored thereon. Machine-readable media can be any available non-transitory media that can be accessed by a general purpose or special purpose computer or other machine with a processor. By way of example, machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Combinations of the above are also included within the scope of machine-readable media. Machine-executable instructions comprise, for example, instructions and data which cause a general purpose computer, special purpose computer, or special purpose processing machine to perform a certain function or group of functions. Software implementations could be accomplished with standard programming techniques with rule based logic and other logic to accomplish the various connection steps, processing steps, comparison steps and decision steps.

While the exemplary embodiments illustrated in the figures and described herein are presently preferred, it should be understood that these embodiments are offered by way of example only. Other substitutions, modifications, changes and omissions may be made in the design, operating conditions and arrangement of the exemplary embodiments without departing from the scope of the present application. Accordingly, the present application is not limited to a particular embodiment, but extends to various modifications that nevertheless fall within the scope of the appended claims. It should also be understood that the phraseology and terminology employed herein is for the purpose of description only and should not be regarded as limiting.

It is important to note that the construction and arrangement of the present application as shown in the various exemplary embodiments is illustrative only. Only certain features and embodiments of the invention have been shown and described in the application and many modifications and changes may occur to those skilled in the art (e.g., variations in sizes, dimensions, structures, shapes and proportions of the various elements, values of parameters (e.g., temperatures, pressures, etc.), mounting arrangements, use of materials, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. An automation and motion control system to control a plurality of theatrical objects, the control system comprising:
a plurality of nodes in communication with each other over a real time network, each node of the plurality of nodes comprising a microprocessor and a memory device;
a safety controller connected to one node of the plurality of nodes, the safety controller being operable to implement an emergency stop system;
a control device, the control device comprising a connector to enable the control device to connect to a node of the plurality of nodes, the control device communicating with the safety controller over the real time network in response to being connected to the node of the plurality of nodes, the control device being operable to issue emergency stop commands to the safety controller once connected to the node of the plurality of nodes; and
the connector being configured to enable the control device to be disconnected from a first node of the plurality of nodes and connected to a second node of the plurality of nodes at a different location from the first node.

2. The automation and motion control system of claim 1 wherein the connector connects to the node at an interface supplying both power and communication to the control device.

3. The automation and motion control system of claim 2 wherein the connector and interface are configured for one of a power over Ethernet connection or a universal serial bus connection.

4. The automation and motion control system of claim 1 wherein the control device comprises at least one input device to be used by an operator of the control device.

5. The automation and motion control system of claim 4 wherein the at least one input device comprises a stop control input device.

6. The automation and motion control system of claim 5 wherein the at least one input device further comprises one or more of a reset control input device or a programmable control input device.

7. The automation and motion control system of claim 6 wherein the at least one input device comprises at least one of a pushbutton or a touchscreen button.

8. The automation and motion control system of claim 5 wherein the stop control input device is a pushbutton.

9. The automation and motion control system of claim 1 wherein the node of the plurality of nodes having the connection to the control device additionally controls a component of the automation and motion control system.

10. The automation and motion control system of claim 1 wherein the control device is battery powered.

11. An emergency stop control device for an automation and motion control system, the control device comprising:
a housing having a predetermined size to permit an operator to carry and hold the housing;
a microprocessor and a memory device positioned inside the housing;
a connector extending from the housing to connect to a node of the automation and motion control system;
a stop control button located on the outer surface of the housing, the stop control button being operable to issue an emergency stop command to a safety controller of the automation and motion control system in response to being connected to the node and the stop control button being activated; and
the connector being configured to enable the control device to be disconnected from the node and connected to another node of the automation and motion control system at a different location.

12. The emergency stop control device of claim 11 wherein the connector connects to each node at an interface supplying both power and communication to the control device.

13. The emergency stop control device of claim 12 wherein the connector and interface are configured for one of a power over Ethernet connection or a universal serial bus connection.

14. The emergency stop control device of claim 11 wherein the stop control button comprises one of a pushbutton or a touchscreen button.

15. The emergency stop control device of claim 11 further comprises one or more of a reset control button or a programmable control button, the reset control button being operable to issue the reset command to a safety controller of the automation and motion control system in response to being connected to the node and the reset control button being activated, the programmable control button being operable to issue an operator established command to the automation and motion control system in response to being connected to the node and the programmable control button being activated.

16. A computer implemented method of using an emergency stop control device with an automation and motion control system, the method comprising:
determining whether an emergency stop control device has been connected to an automation and motion control system;
notifying a safety controller of the automation and motion control system that the emergency stop control device has been connected;
receiving acknowledgement from the safety controller at the connected emergency stop control device;
determining whether a control button on the emergency stop control device has been activated; and
providing the safety controller with a command from the emergency stop control device in response to a determination that the control button on the emergency stop control device has been activated.

17. The computer implemented method of claim 16 further comprises determining whether the emergency stop control device is still connected to the automation and motion control system in response to a determination that the control button on the emergency stop control device has not been activated.

18. The computer implemented method of claim 17 further comprises returning to said determining whether a control button on the emergency stop control device has been activated in response to a determination that the emergency stop control device is still connected.

19. The computer implemented method of claim 16 wherein the emergency stop control device is connected to the automation and motion control system using one of a power over Ethernet connection or a universal serial bus connection.

20. The computer implemented method of claim 16 further comprises repeating said determining whether an emergency stop control device has been connected, said notifying a safety controller that the emergency stop control device has been connected, said receiving acknowledgement from the safety controller, said determining whether a control button on the emergency stop control device has been activated in response to the emergency stop control device being connected to the automation and motion control system at a new location.
